(19) United States
(12) Patent Application Publication
(10) Pub. No.: US 2022/0281695 A1
(43) Pub. Date: Sep. 8, 2022

(54) CONTAINER TRANSPORT ARRANGEMENT TO TRANSPORT CONTAINERS, SUCH AS BEVERAGE BOTTLES OR SIMILAR CONTAINERS

(71) Applicant: KHS GMBH, DORTMUND (DE)

(72) Inventors: Andreas FAHLDIECK, Idar-Oberstein (DE); Nils SCHUG, Riesweiler (DE); Andreas KRIEG, Dittelsheim-Hessloch (DE)

(73) Assignee: KHS GMBH, DORTMUND (DE)

(21) Appl. No.: 17/700,684

(22) Filed: Mar. 22, 2022

Related U.S. Application Data
(63) Continuation-in-part of application No. PCT/EP2020/075009, filed on Sep. 8, 2020.

(30) Foreign Application Priority Data
Sep. 24, 2019 (DE) 102019125603.8

(51) Int. Cl. B65G 47/92; B65G 47/90; B25J 15/02

(52) U.S. Cl. CPC B65G 47/92; B65G 47/904; B25J 15/0206; B25J 15/0246; B65G 2201/0244

(57) ABSTRACT

A container transport arrangement is used to transport containers, such as beverage bottles or similar containers, which container transport arrangement has adjustable container transport devices.

### CROSS-REFERENCE TO RELATED APPLICATIONS

The present application is a Continuation-in-Part of International Patent Application No. PCT/EP2020/075009, filed Sep. 8, 2020, which claims the benefit of Federal Republic of Germany Patent Application No. DE102019125603.8, filed Sep. 24, 2019, each of which is incorporated by reference herein in its entirety.

### BACKGROUND INFORMATION

### 1. Technical Field

The present application relates to container transport arrangement to transport containers, such as beverage bottles or similar containers. The present application further relates to an apparatus for a container handling system, such as can be used in container handling machines in the beverage industry. Such container handling machines are usually capable of handling more than 10,000 containers per hour, or possibly more than 50,000 containers per hour.

### 2. Background Art

This section is for informational purposes only and does not necessarily admit that any publications discussed or referred to herein, if any, are prior art.

Some examples of container handling machines are container filling machines, such as beverage bottle filling machines, or simply filling machines, which are used in the container or beverage bottle filling or bottling industry to fill containers, such as beverage bottles, with a liquid beverage. Such machines can be of a rotary or linear design. Rotary beverage bottle filling machines include a rotary carousel or rotor or similar structure that has a plurality of individual beverage bottle filling devices or beverage bottle filling stations mounted or positioned on the perimeter or periphery thereof. In operation, an individual beverage bottle is received or picked up from a bottle or container handling device or machine, such as another bottle treatment machine or a container transport or conveyor, which can be either of a rotary or linear design, and held at a corresponding individual filling device or station. While the rotary carousel rotates, each individual filling device or filling station dispenses a beverage, such as soft drinks and sodas, wine, beer, fruit juices, water, or other beverages, or another liquid product. Each individual filling device is usually designed to fill one beverage bottle or similar container at a time. Upon completion of filling, the beverage bottle or container is released or transferred to yet another bottle or container handling device or machine, such as another bottle treatment machine or transport device. The filling devices are therefore designed to fully dispense a predetermined or desired amount or volume of product into the beverage bottles or containers before the beverage bottles or containers reach the exit or transfer position out from the filling machine. The beverage bottle filling machine can also be of a linear design, wherein beverage bottles are moved to one or more filling positions along a straight or linear path.

Such filling machines are usually part of a filling or bottling plant, wherein the filling machine operates in conjunction with a number of other beverage bottle or container handling machines, such as a closing machine for placing caps or closures on filled containers, a container manufacturing machine for making or forming containers to be filled, and a container packaging machine for packaging individual containers for shipment and sale to consumers. Such plants are designed to operate as quickly and continuously as possible, and any interruptions in operation result in a loss of productivity and an increase in operating costs, especially since such plants can process large numbers of containers, such as, for example, anywhere from ten to seventy thousand containers per hour or possibly more. The containers can often be made of glass or plastic, such as polyethylene terephthalate (PET).

Transport arrangements can be used to hold and transport the containers at different locations in a container manufacturing plant, such as in the container handling machines or the container transfer devices designed to move containers into, out of, and between container handling machines or other locations or machines.

Such apparatuses for transporting containers in such container handling machines are generally known in the bottling and container handling industry to have different structural embodiments, whether as passive gripper elements or as active clamps, such as, for example, for engaging in a circumferential groove provided at or in the region of the container neck of PET bottles. While such gripper-type transport elements or devices are specifically disclosed herein with respect to at least one possible exemplary embodiment of the present application, it should be understood that the disclosure of the present application is not restricted to this particular design, and the concepts, characteristics, and features of at least one possible exemplary embodiment disclosed herein may be applied in container transport elements or devices of a different design.

There are application situations in which it is possible, for example, with systems with a direct block arrangement, such as when a blower machine transfers bottles into the filler by way of several star conveyors without a buffer segment, that an imprecise bottle transfer may occur due to tolerances, incurred, for example, due to star conveyors as transport elements running with an angle offset and/or height offset. Depending on the transfer situation, containers may not be transferred correctly to the next star, as a result of which the containers themselves, or parts of the transport apparatus, may be damaged. With such faulty transfers, under unfavorable circumstances such high forces can occur that damage to the system may be incurred, wherein frequently not only are individual container grippers destroyed, but also more extensive damage can also be caused to the system as a whole.

Current developments in environmental protection and the fall in the costs of manufacture of PET bottles have brought the technical problem situation with regard to imprecise container transfer more sharply into focus, since the circumferential grooves in the neck region of the containers are constantly being configured to be smaller and smaller. Moreover, if it is also considered that, with the generic apparatuses for transporting containers as circulating transport elements, use is made of what are referred to as star plates, which, due to their form of manufacture, unavoidably involve a height impact, this height impact of the star plates, in conjunction with the grooves of the containers constantly becoming smaller, therefore exacerbates the problem of imprecise container transfer.

Furthermore, the operating conditions which prevail in practice, such as, for example, temperature fluctuations, faults in installation or operation, or operational disruption due, for example, to containers becoming jammed, lead to the transport elements configured as star plates very frequently undergoing plastic deformation after only a short period of time, and therefore incur a height impact which is too great for an exact container transfer by use of the container grippers.

In other words, in many container handling systems, a rotary design is utilized for the container handling machines. A rotor or rotary carousel is used, which rotor has a plurality of container handling positions or devices located at or on the periphery of the rotor, usually spaced apart at equal intervals or angular distances or spacing. These container handling devices often engage and hold the containers, such as beverage bottles, by or at a neck region of the container, which is usually the portion of the container having a small or the smallest diameter. Multiple rotary machines, and thus multiple rotors, are utilized in a container manufacturing plant. The containers are transferred from rotor to rotor while the rotors are rotating at a high speed, such as when processing 10,000 or 50,000 or more containers per hour. The rotors are generally positioned next to one another so as to form a transfer region where the rotors are closest, i.e., where the rotors almost touch or are tangentially positioned with respect to each other. In order to transfer a container between rotors, the rotors are synchronized or matched in rotational speed, height, angular spacing, and other such factors, such that two container handling devices, one from each rotor, arrive at the transfer position at the same or essentially the same time to permit a container held by a first container handling device to be released or moved therefrom to a second container handling device. While this synchronization should be relatively precise due to the high handling speeds, accommodation can be made for factors that could impact the accurate and smooth transfer of the containers, such as manufacturing tolerances, radial runout or the rotor being out of round, changes in dimensions due to wear or temperature fluctuations, inconsistent height or vertical positioning, tilt or angular deviation from a desired position such as horizontal or perpendicular to the vertical, or other such disruptive factors or conditions. However, modern containers are being made smaller and smaller to reduce material costs, storage and transport costs, and environmental impact of waste. As a result, the neck regions are being made to have even smaller diameters. Such small diameters necessitate even greater precision and accuracy at the transfer region because even a small deviation in the synchronized engagement between two container handling devices can result in the container being mishandled, or not being smoothly transferred, or possibly even being jammed between the two rotors. Such situations could result in the container being damaged and/or the container handling devices being subjected to excessive wear and tear and possibly even severe damage or breakage.

### SUMMARY

In view of the above, an object of at least one possible exemplary embodiment of the present application is to provide an apparatus for transporting containers which avoids such disadvantages of known container handling devices and systems, and in this situation allows and promotes an exact or precise container transfer, even in the event of height impact and/or plastic deformation of the transport element configured as a star plate.

The object can be achieved or resolved by an apparatus for transporting containers in accordance with at least one possible exemplary embodiment disclosed herein.

At least one possible exemplary embodiment relates to an apparatus for the transporting of containers comprising at least one transport element circulating in a horizontal plane. Moreover, the transport element also circulates about a vertical machine axis. In addition to this, at least one container gripper is provided at the transport element for the gripping and holding of the containers.

In this situation, the at least one container gripper comprises at least one first and one second gripper arm, pivotable in each case, which are each arranged such as to be able to pivot about a pivot axis oriented parallel or essentially parallel to the machine axis, between a gripping position in which the gripper can grip a respective container and a release position in which the gripper can release the corresponding container.

In accordance with at least one possible exemplary embodiment, the at least one container gripper comprises at least one adjustment device for at least one adjustable height position of the at least one container gripper relative to the plane. According to one embodiment variant, provision can be made in this situation for the adjustment device to be configured such as to increase and/or reduce the perpendicular distance interval between the free ends of the gripper arms of the at least one container gripper and the plane.

According to a further embodiment variant, provision can be made in this situation for the adjustment device to be configured such as to pivot the free ends of the gripper arms of the at least one container gripper in relation to the plane, such that a relative angle setting of the gripper arms is adjustable in relation to the plane by use of the adjustable device.

According to a further embodiment variant, provision can be made in this situation for the pivoting about a pivot axis to be carried out by an adjustment of the relative distance interval of a bearing section of the bearing and holding element to the transport element, by use of an adjustment element of the adjustment apparatus, in such a way that the bearing section of the bearing and holding element can be moved, by use of the adjustment element, in the direction of the transport element, as well as in a direction opposite to this.

According to a further embodiment variant, provision can be made in this situation for the adjustment element to comprise a holding section as well as an adjustment section, wherein the bearing section of the bearing and holding element is arranged at the holding section, and the adjustment section is configured as movable relative to the transport element as well as being connected to transport element.

According to a further embodiment variant, provision can be made in this situation for the adjustment element of the adjustment device to be configured in the form of a bolt, and for the adjustment section to be connected immediately adjacent to the holding section along the longitudinal extension of the adjustment element.

According to a further embodiment variant, provision can be made in this situation for the adjustment section to be configured as a threaded section, which is accommodated in a corresponding thread of the transport element, in particular screwed into it.

According to a further embodiment variant, provision can be made in this situation for the adjustment device to be fixed in position at its part section penetrating through the transport element by use of a locknut.

According to a further embodiment variant, provision can be made in this situation for the bearing and holding element to be arranged fixed in position in particular with its bearing section at the holding section of the adjustment element.

According to a further embodiment variant, provision can be made in this situation for the adjustment element to be formed, at least in the region of its holding section, from a magnetizable material, in particular from a magnetizable steel or iron material, and wherein the holding section interacts magnetically with a permanent magnet which is securely arranged in the bearing section of the bearing and holding element.

According to a further embodiment variant, provision can be made in this situation for the permanent magnet and the holding section to interact in such a way that the bearing and holding element are held in fixed positions at the holding section and/or are secured against falling out, and in particular against an unwanted withdrawal of the adjustment element from the holding section.

According to a further embodiment variant, provision can be made in this situation for the adjustment device to comprise a further adjustment element, which can be moved with its free end against the underside of the transport element.

According to a further embodiment variant, provision can be made in this situation for the further adjustment element to be configured as a threaded bolt, which with its free end provides support, by contact positive fit and/or by non-positive fit, on the underside of the transport element.

According to a further embodiment variant, provision can be made in this situation for the apparatus to comprise several container grippers, wherein all the container grippers comprise an adjustment device according to at least one possible exemplary embodiment.

According to a further embodiment variant, provision can be made in this situation for each container gripper to be configured such as to be individually adjustable by use of a respective adjustment device.

The term “container” is understood in the meaning of the present application to mean any types of containers, in particular bottles, cans, beakers, etc., in each case of metal, glass, and/or plastic, preferably of PET (polyethylene terephthalate).

The expression “essentially” or “approximately” signifies in the meaning of the present application deviations from the exact value by +/−10%, or by +/−5%, and/or deviations in the form of changes which are not of significance to the function.

It should be noted that a positive fit or positive force or positive guidance, in the context of this application, refers to a situation in which at least two components engage in a form fit, that is, at least a portion of an outer edge or boundary or surface of a first component substantially or essentially conforms to or fits within a corresponding portion of an inner edge or boundary or surface of a second component. This form fit between the two components results in the first component being retained against movement or displacement out of engagement with the second component. A common type of positive fit is when a first component is bound on at least one side or portion by a retaining structure, such as a side wall or guide surface, of a second component, such that, when a force is applied to move the first component in the direction of and against the retaining structure of the second component, the retaining structure resists movement or displacement of the first component, that is, the retaining structure acts like a wall or similar to block the movement. Male and female components that are connected by tabs or shoulders are another example of a positive or form fit. A positive guidance can occur when the first component is movable and the second component is a guide structure, wherein as the first component is moved into contact with the second component, the first component is deflected or guided along the path of movement defined or bounded by the second component. Again, the movement or displacement of the first component in a certain direction is resisted or blocked by the guide wall or surface of the second component, such that the first component is physically deflected or guided by the second component in a different direction or path of movement.

It should also be noted that a non-positive fit or non-positive force or non-positive guidance, in the context of this application, refers to a situation in which at least two components engage in a friction fit, that is, at least a portion of an edge or boundary or surface of a first component is in frictional engagement or contact with a corresponding portion of an edge or boundary or surface of a second component. This friction fit between the two components results in the first component being retained by friction against a sliding or translating movement or displacement with respect to the second component. A common type of non-positive fit is when a surface portion of the first component is positioned in contact with a corresponding or matching surface portion of the second component, such that, when a force is applied to move the first component along or across the surface portion of the second component, the friction between the surfaces at least resists movement or displacement of the first component, and prevents movement if the friction force is greater than the movement force. It is not uncommon for two components to engage in both a positive fit due to at least a partially matching or corresponding structural design that forms a retaining surface, and a non-positive fit due to frictional forces between surfaces of the components that are in frictional contact with one another. In such a situation, the positive fit and non-positive combine to produce a greater retaining or resisting force than would be generated or provided by one or the other alone.

Further embodiments, advantages, and possible applications of at least one possible exemplary embodiment also derive from the following description of exemplary embodiments and from the figures. In this situation, all the features described and/or represented in the figures are in principle the object of the invention, regardless of their association in the claims or reference to them.

### BRIEF DESCRIPTION OF THE DRAWINGS

FIG. 1 shows at least one possible exemplary embodiment of a container handling device in a partially sectioned perspective view;

FIG. 2 shows the region designated as A in FIG. 1, in an enlarged representation;

FIG. 3 shows at least one possible exemplary embodiment of a container handling device in a partially sectioned perspective view;

FIG. 4 shows the region designated as B in FIG. 3 in an enlarged representation;

FIG. 5 a transport element in isolation, in a side sectional representation, with retaining bolts arranged on it; and

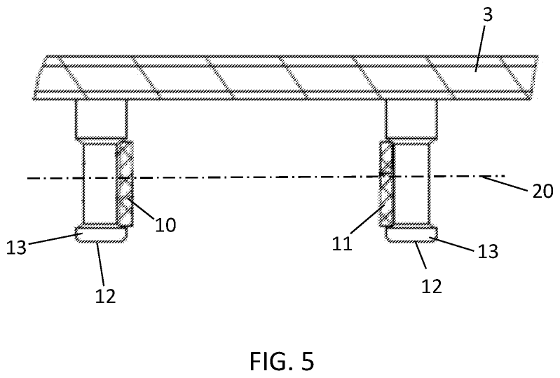

FIG. 6 shows at least one possible exemplary embodiment of a container gripper shown in isolation, in a perspective view from beneath.

### DETAILED DESCRIPTION

Identical reference numbers are used in the figures for elements of at least one possible exemplary embodiment that are the same or have the same effect. Moreover, for the sake of easier overview, some components unnecessary for the description of the respective figure are not marked with reference numerals.

In the figures, in general, a transport apparatus 1 for transporting containers is shown. The containers, which are not represented in any greater detail, are bottles, such as large-volume bottles, and in this context are made of plastic or PET, and comprise a container neck configured in the form of a groove or a container neck with at least one groove. The transport apparatus 1 comprises, among other elements, a transport element 3 arranged in an essentially horizontal plane E and capable of being driven such as to circulate about a vertical machine axis MA, which is configured as a star plate or similar rotary device. In other words, therefore, the transport element 3, configured as a flat surface, spans the plane E, which runs approximately or essentially perpendicular to a machine axis MA.

Provided at the circumference of the transport element 3, such as at equal angular distances about the machine axis MA and offset to one another, are several container grippers 4, which can be configured for the suspended holding in each case of a container by its container neck or neck ring, or by a groove provided on the container neck below the container opening. The container gripper 4 of the transport apparatus 1 is arranged or disposed below the plane E at the transport element.

In the exemplary embodiment represented, the respective container gripper 4 comprises in each case a first and a second pivotable gripper arm 5, 6, which in each case are arranged such as to pivot about a pivot axis SA, oriented parallel to the machine axis MA, between a gripping position GP gripping the respective container and a release position FP in which the corresponding container is released.

The respective container grippers 4 comprise in general a storing and holding element 2 with a bearing section 2.1 and a holding section 2.2. The bearing and holding element 2 is held in this situation in an adjustable manner with its bearing section 2.1 at an adjustment element 7 of an adjustment device 8. In addition to this, the two gripper arms 5 and 6 are accommodated at the bearing section 2.1 of the bearing and holding element 2 such as to be able to pivot or rotate about their respective pivot axis SA. The gripper arms 5, 6 are further held together under preliminary tension by use of a tension spring 9. The holding section 2.2 of the bearing and holding element 2 is configured, for example, in the form of two shaped holding arms 10 and 11. The holding arms 10, 11 extend in this situation going out from the bearing and holding element 3 in the direction of the engagement opening of the gripper arms 5 and 6.

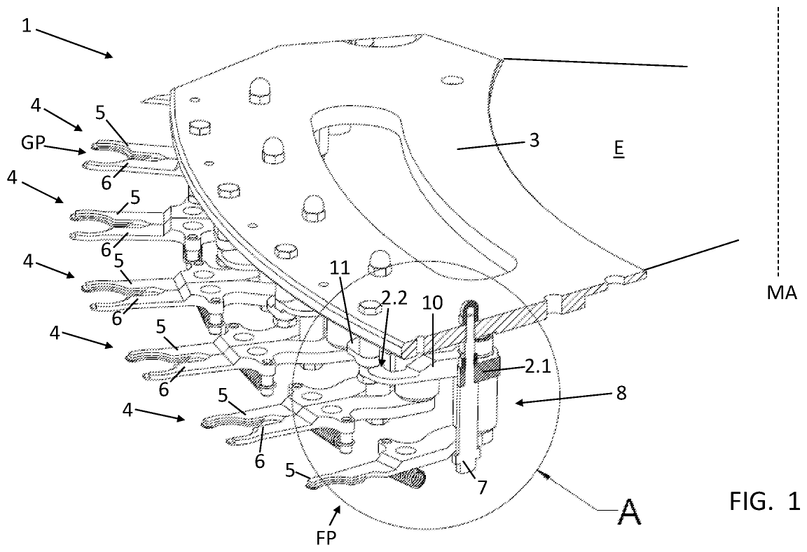

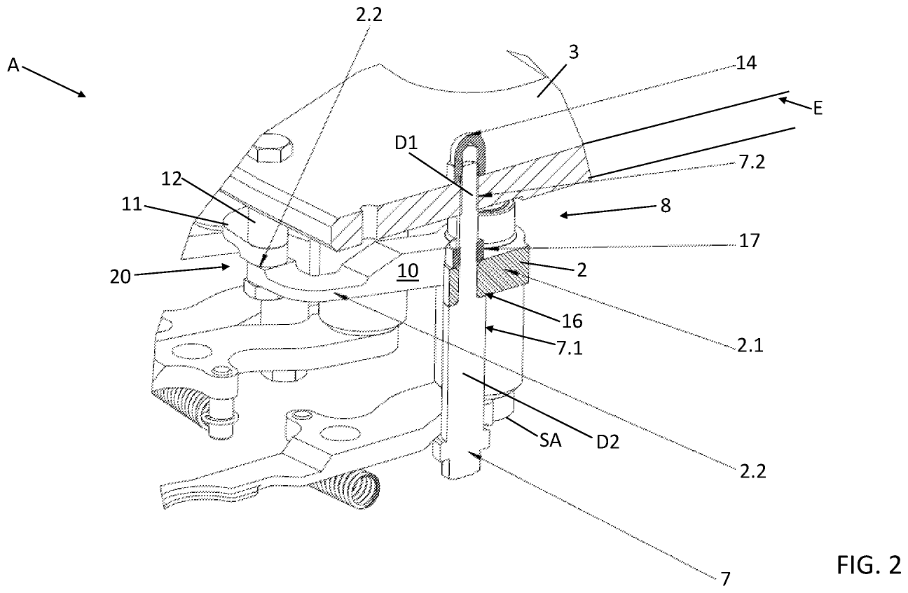

In the embodiment variant of FIGS. 1 and 2, the holding arms 10, 11 are connected securely in the region of their respective free ends, in each case by a retaining device 12, to the transport element 3, but in a detachable manner, for example screwed. In this situation the respective holding device 12 can be configured as a screw or threaded bolt or similar structure. For this purpose, in accordance with at least one possible exemplary embodiment, the holding section 2.2 of the bearing and holding element 2 is configured as a holding element which is essentially U-shaped in a view from above, which can be produced or manufactured from sheet steel or similar material, for example. In accordance with at least one possible exemplary embodiment, the bearing and holding element 2 is configured as a retaining plate and exhibits a thickness which reduces or decreases from the bearing section 2.1 in the direction of the holding section 2.2, as a result of which a deformation can be produced or permitted, which can be incurred by an adjustment in the height or an adjustment of the angular distance.

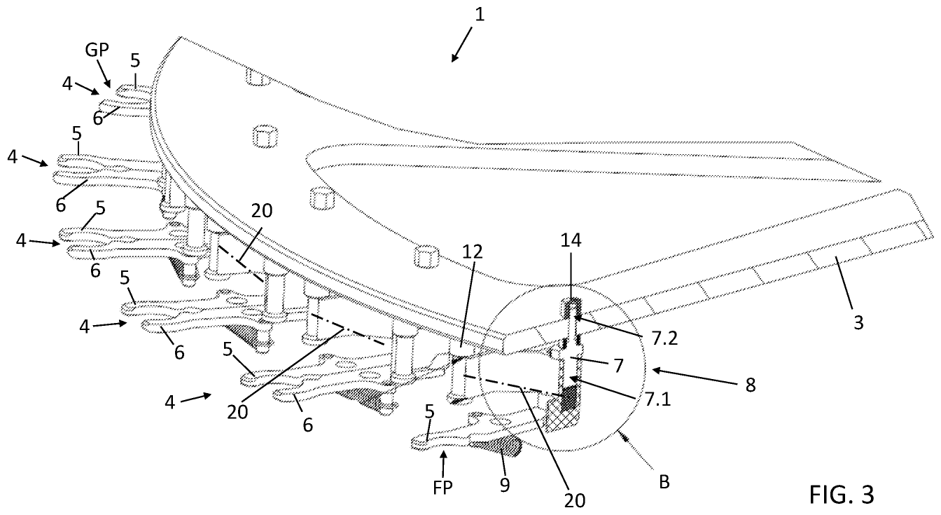

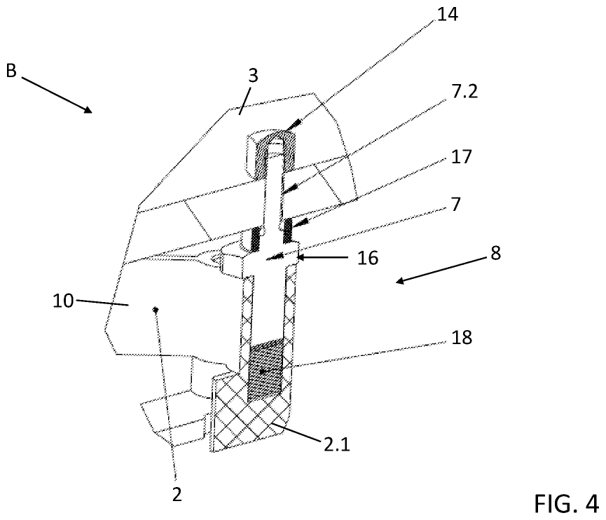

In comparison with this, the holding arms 10, 11 of the arms of the holding sections 2.2 in the embodiment variants of FIGS. 3 and 4, in the normal position, rest on or in plate-shaped heads 13 of the holding device 12, likewise arranged in fixed positions at the transport element 3. In this situation, the holding device 12 can also be configured in the embodiment variants from FIGS. 3 and 4 as screws or bolts. In greater detail, in this situation the holding arms 10, 11 are arranged as tensioned under a preliminary tension between the two holding device 12, as well as resting on the heads 13 of the corresponding holding device 12.

In this situation, the holding device 12 can exhibit, in the region of their respective heads 13, a configuration that is conical, at least in sections in the longitudinal direction, in order to avoid play between the holding arms 10, 11 and the holding device 12. In addition, the respective holding device 12 also exhibits a configuration that is conical, at least in sections, on the side opposite the corresponding heads 13, along the longitudinal direction of the holding device 12, in such a way that the corresponding holding arm 10, 11 can be received, under tension, between the opposing conical configurations along the longitudinal extension of the holding device 12.

In order to be able to replace the container gripper 4, the two holding arms 10 and 11 can be pressed together to disengage from the holding devices 12, which permits the container grippers 4 to be moved downwards and out of the adjustment element 7. This form of assembly takes advantage of the fact that, in the event of a certain stress on the respective container gripper 4 being exceeded, an automatic lateral pivoting of the respective container grippers 4 is caused at the transport element 3. An example of a container handling arrangement comprising pivotable container grippers, components of which may be utilized or adapted for use in at least one possible exemplary embodiment, may be found in U.S. Pat. No. 8,602,471 B2, which is incorporated by reference as if set forth herein in its entirety.

According to at least one possible exemplary embodiment, provision is made for the at least one gripper holder 4 to comprise at least one adjustment device 8 for at least one adjustable height location of the at least one container gripper 4 relative to the horizontal plane E. Height location is understood, in accordance with at least one possible exemplary embodiment, to be the perpendicular distance interval of this container gripper 4 in the region of the free ends of its gripper arms 5, 6, i.e. at the gripper tips, to the plane E spanned by the transport element 3.

In this situation, the adjustment device 8 is configured in such a way as to increase and/or reduce the perpendicular distance interval between the free ends of the respective gripper arms 5, 6 of a container gripper 4 and the horizontal plane E.

In greater detail, in this situation the adjustment device 8 is configured such as to pivot the free ends of the respective gripper arms 5, 6 of a container gripper 4 in relation to the horizontal plane E, wherein, by a pivoting of the gripper arms 5, 6 in a first direction, the perpendicular distance interval between the free ends of the gripper arms 5, 6 and the plane E is reduced, and, by a pivoting in a second direction opposite to the first direction, the perpendicular distance interval between the free ends of the gripper arms 5, 6 and the plane E is increased.

For this purpose, a pivot axis 20 can be formed at the respective container gripper 4 in the region of the free ends of the holding arms 10, 11, about which there then pivot the adjustment device 8, the corresponding container grippers 4, and therefore, finally, also the gripper arms 5, 6.

The pivot axis 20 can also be an imaginary line, about which at least parts of the container gripper 4 move.

In this situation, the pivoting about the pivot axis 20, by the adjustment of the relative distance interval of the bearing and holding element 2 in the region of the bearing section 2.1 to the transport element 3, can be achieved by use of the adjustment element 7 of the adjustment device 8. In this situation, provision can be made for the bearing section 2.1 of the bearing and holding element 2 to be moved by use of the adjustment element 7 in the direction of the transport element 3, as well as in a direction opposite to this.

In greater detail, provision can be made for this purpose for the adjustment element 7 to exhibit a holding section 7.1 and an adjustment section 7.2, wherein the bearing section 2.1 of the bearing and holding element 2 is located arranged at the holding section 7.1, and the adjustment section 7.2 is movably connected to the transport element 3.

In this situation, the adjustment element 7 is configured in the form of a bolt, and the adjustment section 7.2 connects adjacent or immediately adjacent to the holding section 7.1 along the longitudinal extension of the adjustment element 7. In accordance with at least one possible exemplary embodiment, the adjustment element 7 is configured in this situation as an adjustment bolt, which exhibits an external thread at least in the region of its adjustment section 7.2.

The adjustment section 7.2 can be configured in this situation as a thread section, which is received, such as by screwing, in a corresponding thread of the transport element 3. In accordance with at least one possible exemplary embodiment, in this situation the adjustment section 7.2 comprises an outer thread, or is configured as an outer thread, which is screwed into an inner thread corresponding to the transport element 3.

By rotating the adjustment section 7.2 clockwise, for example, it is possible for the holding section 7.1 of the adjustment element 7 to be moved in the direction of the transport element 3. Conversely, for example, by rotating the adjustment section 7.2 counterclockwise, the holding section 7.1 of the adjustment element 7 is moved away from the transport element 3.

In this situation, the adjustment section 7.2 is fixed in position at the part section projecting through the transport element 3 by use of a locknut 14.

In this case, in the region of the holding section 7.1 of the adjustment element 7, at least the bearing and holding element 2 is arranged and received in a fixed position in relation to the adjustment element 7.

In the embodiment variant from FIGS. 1 and 2, the adjustment element 7 exhibits a first diameter D1 and a second diameter D2 that increases abruptly in relation to the first diameter D1, such that, at the transition from the first diameter D1 to the second diameter D2, a type of collar or shoulder 16 is provided, which forms a stop for the bearing and holding element 2. The bearing and holding element 2 is in this situation in positive contact fit with its first side on the collar 16, while the second side opposite the first side is secured in a fixed position by use of a nut 17.

In the embodiment variant from FIGS. 3 and 4, the adjustment element 7 is formed, at least in the region of its holding section 7.1, from a magnetizable material, such as a magnetizable steel or iron or similar material, which interacts magnetically with a magnet or permanent magnet 18 or similar structure, arranged secured in the bearing section 2.1 of the bearing and holding element 2. In accordance with at least one possible exemplary embodiment, the permanent magnet 18 and the magnetic holding section 7.1 interact in such a way that the bearing and holding element 2 is held in a fixed position on the one hand, and, on the other, is secured against falling out or the withdrawing of the holding section 7.1 of the adjustment element 7. In addition, the adjustment element 7 is provided with a seal between the collar 16 and the transport element 3.

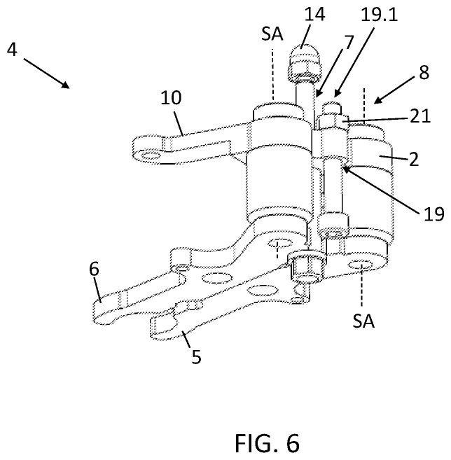

FIG. 6 shows at least one possible exemplary embodiment of an apparatus for transporting containers, with which the adjustment device 8, in differentiation to the embodiment variant from FIGS. 1 and 2, comprises a further adjustment element 19 in addition to the adjustment element 7. The further adjustment element 19 is in this case likewise arranged in the region of the bearing section 2.1 at the bearing and holding element 2. In accordance with at least one possible exemplary embodiment, the further adjustment element 19 is configured as a threaded bolt, which is supported with its free end 19.1 in positive and/or non-positive fit on the underside of the transport element 3. A locknut 20 is provided for this purpose, by use of which the free end 19.1 of the further adjustment element 19 can be moved against the underside of the transport element 3 and/or held there in a fixed position, such as by being pressed against it.

According to one embodiment variant, provision is made for all the container grippers 4 to comprise an adjustment device 8. Provision is further made for each container gripper 4 to be individually adjustable, at least in its height position, by use of its respective adjustment device 8.

The invention has been described heretofore by way of exemplary embodiments. It is understood that a large number of modifications or derivations are possible, without thereby departing from the scope of protection of the invention defined by the claims.

The following is at least a partial list of components shown in the figures and their related reference numerals: transport device 1; bearing and holding element 2; bearing section 2.1; holding section 2.2; transport element 3; container gripper 4; gripper arm 5; gripper arm 6; adjustment element 7; holding section 7.1; adjustment section 7.2; adjustment device 8; tension spring 9; holding arm 10; holding arm 11; holding device 12; head 13; locknut 14; collar 16; nut 17; permanent magnet 18; adjustment element 19; free end 19.1; pivot axis 20; locknut 21; first diameter D1; second diameter D2; machine axis MA; pivot axis SA; gripping position GP; releasing position FP; and plane E.

At least one possible exemplary embodiment of the present application relates to an apparatus for transporting containers, comprising at least one transport element 3 circulating in an essentially horizontal plane E as well as about a vertical machine axis MA, provided at which is at least one container gripper 4 for gripping and holding the containers, wherein the at least one container gripper 4 comprises at least one first and one second gripper arm 5, 6 that in each case can pivot, and which in each case are arranged so as to be capable of pivoting about a pivot axis SA, oriented parallel to the machine axis MA, between a position GP gripping the respective container and a position FP releasing the corresponding container, wherein the at least one container gripper 4 comprises at least one adjustment device 8 for at least one adjustable height position of the at least one container gripper 4 relative to the plane E.

At least one other possible exemplary embodiment of the present application relates to the apparatus for transporting containers, wherein the adjustment device 8 is configured such as to increase and/or reduce the perpendicular distance interval between the free ends of the gripper arms 5, 6 of the at least one container gripper 4 and the plane E.

At least one other possible exemplary embodiment of the present application relates to the apparatus for transporting containers, wherein the adjustment device 8 is configured such as to pivot the free ends of the gripper arms 5, 6 of the at least one container gripper 4 in relation to the plane E in such a way that a relative angle position of the gripper arms 5, 6 to the plane E is configured as adjustable by use of the adjustment device 8.

At least one other possible exemplary embodiment of the present application relates to the apparatus for transporting containers, wherein the pivoting about a pivot axis 20 can be carried out by an adjustment of the relative distance interval of a bearing section 2.1 of the bearing and holding element 2 to the transport element 3 by use of an adjustment element 7 of the adjustment device 8 in such a way that the bearing section 2.1 of the bearing and holding element 2 can be moved by use of the adjustment element 7 in the direction of the transport element 3 as well in a direction opposite to this.

At least one other possible exemplary embodiment of the present application relates to the apparatus for transporting containers, wherein the adjustment element 7 comprises a holding section 7.1 as well as an adjustment section 7.2, wherein the bearing section 2.1 of the bearing and holding element 2 is arranged at the holding section 7.1, and the adjustment section 7.2 is configured so as to be movable relative to the transport element 3 as well as being connected to the transport element 3.

At least one other possible exemplary embodiment of the present application relates to the apparatus for transporting containers, wherein the adjustment element 7 of the adjustment device 8 is configured in the form of a bolt, and the adjustment section 7.2 connects immediately adjacent to the holding section 7.1 along the longitudinal extension of the adjustment element 7.

At least one other possible exemplary embodiment of the present application relates to the apparatus for transporting containers, wherein the adjustment section 7.2 is configured as a threaded section, which is received in a corresponding thread of the transport element 3, in particular screwed into it.

At least one other possible exemplary embodiment of the present application relates to the apparatus for transporting containers, wherein the adjustment section 7.2 is fixed in position at the part section projecting through the transport element 3 by use of a locknut 14.

At least one other possible exemplary embodiment of the present application relates to the apparatus for transporting containers, wherein the bearing and holding element 2 is arranged fixed in position, in particular by its bearing section 2.1 to the holding section 7.1 of the adjustment element 2.

At least one other possible exemplary embodiment of the present application relates to the apparatus for transporting containers, wherein the adjustment element 7 is formed, at least in the region of its holding section 7.1 from a magnetizable material, in particular a magnetizable steel or iron material, and wherein the holding section 7.1 interacts magnetically with a permanent magnet 18 that is securely arranged in the bearing section 2.1 of the bearing and holding element 2.

At least one other possible exemplary embodiment of the present application relates to the apparatus for transporting containers, wherein the permanent magnet 18 and the holding section 7.1 interact magnetically in such a way that the bearing and holding element 2 is held in a fixed position at the holding section 7.1 and/or is secured against falling out, and in particular also against the unintentional pulling out of the holding section 7.1 of the adjustment element 7.

At least one other possible exemplary embodiment of the present application relates to the apparatus for transporting containers, wherein the adjustment device 8 comprises a further adjustment element 19, which can be moved with its free end 19.1 against the underside of the transport element 3.

At least one other possible exemplary embodiment of the present application relates to the apparatus for transporting containers, wherein the further adjustment element 19 is configured as a threaded bolt, which supports with its free end 19.1 in positive and/or non-positive fit on the underside of the transport element 3.

At least one other possible exemplary embodiment of the present application relates to the apparatus for transporting containers, wherein the device comprises several container grippers 4, wherein all the container grippers 4 comprise an adjustment device 8.

At least one other possible exemplary embodiment of the present application relates to the apparatus for transporting containers, wherein each container gripper 4 is configured as being individually adjustable by use of its respective adjustment device 8.

At least one possible exemplary embodiment of the present application relates to a container transport arrangement configured to transport containers comprising beverage bottles and similar containers in a bottling or container handling machine of a bottling or container handling plant, said container transport arrangement comprising: at least one transport element being configured and disposed to rotate about a vertical machine axis; at least one container gripper being disposed at or on said at least one transport element; said at least one container gripper being configured and disposed to grip and hold containers; said at least one container gripper comprising a first container gripper arm and a second container gripper arm; each of said first container gripper arm and said second container gripper arm being movable about a gripper arm axis oriented parallel or essentially parallel to said vertical machine axis; each of said first container gripper arm and said second container gripper arm being movable to permit adjustment of said at least one container gripper between a gripping position, in which said first container gripper arm and said second container gripper arm being disposed closer together to grip a container, and a release position, in which said first container gripper arm and said second container gripper arm being disposed further apart to permit movement of a container into or out of said at least one container gripper; said at least one container gripper comprising at least one adjustment device; and said at least one adjustment device being adjustable to permit a height adjustment of the vertical position of said at least one container gripper relative to said at least one transport element and a horizontal plant floor surface.

At least one other possible exemplary embodiment of the present application relates to the container transport arrangement, wherein: said at least one transport element comprises a planar surface portion disposed essentially perpendicular to said vertical machine axis; each of said container gripper arms comprises a first end portion and a second end portion; said second end portion is disposed opposite said first end portion and adjacent said at least one adjustment device; and said at least one adjustment device is adjustable to permit adjustment of the distance between said first end portion of each of said container gripper arms and said planar surface portion.

At least one other possible exemplary embodiment of the present application relates to the container transport arrangement, wherein said at least one adjustment device is configured and disposed to pivot said container gripper arms about a pivot axis to adjust an angular position of said container gripper arms with respect to said planar surface portion and thereby adjust the distance between said first end portion of each of said container gripper arms and said planar surface portion.

At least one other possible exemplary embodiment of the present application relates to the container transport arrangement, wherein: said at least one container gripper comprises a bearing arrangement configured and disposed to connect said second end portion of each of said container gripper arms to said at least one adjustment device; said at least one adjustment device comprises an adjustment element; said bearing arrangement comprises a bearing section operatively connected to said adjustment element; and said adjustment element is configured to be movably adjusted to move said bearing arrangement and change a distance between said bearing arrangement and said planar surface portion of said at least one transport element, and thereby pivot said container gripper arms about said pivot axis.

At least one other possible exemplary embodiment of the present application relates to the container transport arrangement, wherein: said adjustment element comprises a holding section and an adjustment section; said bearing section of said bearing arrangement is disposed at said holding section; and said adjustment section is connected to said at least one transport element and configured to be moved relative to said at least one transport element.

At least one other possible exemplary embodiment of the present application relates to the container transport arrangement, wherein: said adjustment element comprises a bolt or similar elongated structure; and said adjustment section is connected to said holding section.

At least one other possible exemplary embodiment of the present application relates to the container transport arrangement, wherein: said adjustment section comprises an external thread; and said at least one transport element comprises an internal thread configured and disposed to engage with said external thread of said adjustment section to adjustably connect or screw together said adjustment section and said at least one transport element.

At least one other possible exemplary embodiment of the present application relates to the container transport arrangement, wherein: said adjustment section is configured and disposed to pass through an opening in said at least one transport element, such that a projecting portion of said adjustment section projects past said planar surface portion; and said at least one adjustment device comprises a threaded locking element configured and disposed to engage with said projecting portion to hold said adjustment element in a fixed position upon installation or adjustment of said adjustment element.

At least one other possible exemplary embodiment of the present application relates to the container transport arrangement, wherein said bearing arrangement is disposed in a fixed position with respect to said holding section of said adjustment element by said bearing section.

At least one other possible exemplary embodiment of the present application relates to the container transport arrangement, wherein: at least said holding section of said adjustment element comprises a magnetizable steel, magnetizable iron, or other magnetizable material; said bearing section comprises a magnet or is connected to a magnet; and said holding section is configured and disposed to magnetically interact with said magnet of said bearing section.

At least one other possible exemplary embodiment of the present application relates to the container transport arrangement, wherein said bearing arrangement is connected to said holding section by magnetic force to at least one of: affix said bearing arrangement to said holding section; secure said bearing arrangement against falling out or off of said holding section; and minimize or prevent unintentional displacement or withdrawal of said holding section out of connection with said bearing arrangement.

At least one other possible exemplary embodiment of the present application relates to the container transport arrangement, wherein: said at least one adjustment device comprises a second adjustment element; said second adjustment element comprises a first end portion and a second portion; said second end portion is disposed opposite said first end portion and adjacent the underside of said at least one transport element; and said second end portion is configured and disposed to engage with or be pressed against the underside of said at least one transport element.

At least one other possible exemplary embodiment of the present application relates to the container transport arrangement, wherein: said second adjustment element comprises a threaded bolt; and said second adjustment element is disposed such that said second end portion is in a positive and/or non-positive fit with the underside of said at least one transport element.

At least one other possible exemplary embodiment of the present application relates to the container transport arrangement, wherein said at least one container gripper comprises a plurality of container grippers.

At least one other possible exemplary embodiment of the present application relates to the container transport arrangement, wherein each of said container grippers is configured to be individually adjusted by its respective adjustment device.

At least one possible exemplary embodiment of the present application relates to a method of adjusting a container transport arrangement configured to transport containers comprising beverage bottles and similar containers in a bottling or container handling machine of a bottling or container handling plant, said container transport arrangement comprising: at least one transport element being configured and disposed to rotate about a vertical machine axis; at least one container gripper being disposed at or on said at least one transport element; said at least one container gripper being configured and disposed to grip and hold containers; said at least one container gripper comprising a first container gripper arm and a second container gripper arm; each of said first container gripper arm and said second container gripper arm being movable about a gripper arm axis oriented parallel or essentially parallel to said vertical machine axis; each of said first container gripper arm and said second container gripper arm being movable to permit adjustment of said at least one container gripper between a gripping position, in which said first container gripper arm and said second container gripper arm being disposed closer together to grip a container, and a release position, in which said first container gripper arm and said second container gripper arm being disposed further apart to permit movement of a container into or out of said at least one container gripper; said at least one container gripper comprising at least one adjustment device; and said at least one adjustment device being adjustable to permit a height adjustment of the vertical position of said at least one container gripper relative to said at least one transport element and a horizontal plant floor surface; and said method comprising adjusting said at least one adjustment device and thereby adjusting the vertical position of said at least one container gripper relative to said at least one transport element and a horizontal plant floor surface.

At least one other possible exemplary embodiment of the present application relates to the method of adjusting a container transport arrangement, wherein: said at least one transport element comprises a planar surface portion disposed essentially perpendicular to said vertical machine axis; each of said container gripper arms comprises a first end portion and a second end portion; said second end portion is disposed opposite said first end portion and adjacent said at least one adjustment device; said at least one adjustment device is adjustable to permit adjustment of the distance between said first end portion of each of said container gripper arms and said planar surface portion; and said step of adjusting said at least one adjustment device comprises adjusting the distance between said first end portion of each of said container gripper arms and said planar surface portion.

At least one other possible exemplary embodiment of the present application relates to the method of adjusting a container transport arrangement, wherein: said at least one adjustment device is configured and disposed to pivot said container gripper arms about a pivot axis to adjust an angular position of said container gripper arms with respect to said planar surface portion and thereby adjust the distance between said first end portion of each of said container gripper arms and said planar surface portion; and said step of adjusting said at least one adjustment device comprises pivoting said container gripper arms about a pivot axis to adjust an angular position of said container gripper arms with respect to said planar surface portion, and thereby adjusting the distance between said first end portion of each of said container gripper arms and said planar surface portion.

At least one other possible exemplary embodiment of the present application relates to the method of adjusting a container transport arrangement, wherein: said at least one container gripper comprises a bearing arrangement configured and disposed to connect said second end portion of each of said container gripper arms to said at least one adjustment device; said at least one adjustment device comprises an adjustment element; said bearing arrangement comprises a bearing section operatively connected to said adjustment element; said adjustment element is configured to be movably adjusted to move said bearing arrangement and change a distance between said bearing arrangement and said planar surface portion of said at least one transport element, and thereby pivot said container gripper arms about said pivot axis; and said method further comprises movably adjusting said adjustment element and thereby moving said bearing arrangement and changing a distance between said bearing arrangement and said planar surface portion of said at least one transport element, and thereby pivoting said container gripper arms about said pivot axis.

At least one other possible exemplary embodiment of the present application relates to the method of adjusting a container transport arrangement, wherein: said adjustment element comprises a holding section and an adjustment section; said bearing section of said bearing arrangement is disposed at said holding section; said adjustment section is connected to said at least one transport element and configured to be moved relative to said at least one transport element; and said method further comprises moving said adjustment section relative to said at least one transport element.

Any numerical values disclosed herein, if any, should be understood as disclosing all approximate values within plus or minus ten percent of the numerical value. Any ranges of numerical values disclosed herein, if any, should be understood as disclosing all individual values within the range of values, including whole numbers, tenths of numbers, or hundredths of numbers.

The entirety of the appended drawings, including all dimensions, proportions, and/or shapes disclosed thereby or reasonably understood therefrom, are hereby incorporated by reference.

All of the patents, patent applications, patent publications, and other documents cited herein, are hereby incorporated by reference as if set forth in their entirety herein.

The corresponding foreign or international patent applications, as originally filed and as published, from which the present application claims the benefit of priority, are hereby incorporated by reference as if set forth in their entirety herein, as follows: PCT/EP2020/075009; WO2021058274; and DE102019125603.8.

The following patents, patent applications, patent publications, and other documents cited in the corresponding foreign or international patent applications listed in the preceding paragraph are hereby incorporated by reference as if set forth in their entirety herein, as follows: EP3239078A1; WO2018162145A1; DE102018113301A1; DE102009043984A1; and DE602005001695T2.

The following patents, patent applications, patent publications, and other documents are hereby incorporated by reference as if set forth in their entirety herein, as follows: DE202006018379U1; DE202006004641U1; DE102009050393A1; DE202005002470U1; and DE102005032175A1. Some examples of container clamps or clips, or components thereof, for use in the beverage bottle or container handling industry, portions of which may be incorporated into or adapted for use with at least one possible exemplary embodiment of the present application, may possibly be found in DE202006018379U1, DE202006004641U1, DE202005002470U1, or DE102005032175A1.

Although the invention has been described in detail for the purpose of illustration of any embodiments disclosed herein, including the most practical or preferred embodiments at the time of filing of this application, it is to be understood that such detail is solely for that purpose and that the invention is not limited to such embodiments, but, on the contrary, is intended to cover modifications and equivalent arrangements that are within the spirit and scope of the present application, including the specification and the claims as originally filed, as amended, or as issued. For example, it is to be understood that the present invention contemplates that, to the extent possible, one or more features or components of any disclosed embodiment can be combined with one or more features or components of any other disclosed embodiment.

What is claimed is:

1. A container transport arrangement configured to transport containers comprising beverage bottles and similar containers in a bottling or container handling machine of a bottling or container handling plant, said container transport arrangement comprising:
at least one transport element being configured and disposed to rotate about a vertical machine axis;
at least one container gripper being disposed at or on said at least one transport element;
said at least one container gripper being configured and disposed to grip and hold containers;
said at least one container gripper comprising a first container gripper arm and a second container gripper arm;
each of said first container gripper arm and said second container gripper arm being movable about a gripper arm axis oriented parallel or essentially parallel to said vertical machine axis;
each of said first container gripper arm and said second container gripper arm being movable to permit adjustment of said at least one container gripper between a gripping position, in which said first container gripper arm and said second container gripper arm being disposed closer together to grip a container, and a release position, in which said first container gripper arm and said second container gripper arm being disposed further apart to permit movement of a container into or out of said at least one container gripper;
said at least one container gripper comprising at least one adjustment device; and
said at least one adjustment device being adjustable to permit a height adjustment of the vertical position of said at least one container gripper relative to said at least one transport element and a horizontal plant floor surface.

2. The container transport arrangement according to claim 1, wherein:
said at least one transport element comprises a planar surface portion disposed essentially perpendicular to said vertical machine axis;
each of said container gripper arms comprises a first end portion and a second end portion;
said second end portion is disposed opposite said first end portion and adjacent said at least one adjustment device; and
said at least one adjustment device is adjustable to permit adjustment of the distance between said first end portion of each of said container gripper arms and said planar surface portion.

3. The container transport arrangement according to claim 2, wherein said at least one adjustment device is configured and disposed to pivot said container gripper arms about a pivot axis to adjust an angular position of said container gripper arms with respect to said planar surface portion and thereby adjust the distance between said first end portion of each of said container gripper arms and said planar surface portion.

4. The container transport arrangement according to claim 3, wherein:
said at least one container gripper comprises a bearing arrangement configured and disposed to connect said second end portion of each of said container gripper arms to said at least one adjustment device;
said at least one adjustment device comprises an adjustment element;
said bearing arrangement comprises a bearing section operatively connected to said adjustment element; and
said adjustment element is configured to be movably adjusted to move said bearing arrangement and change a distance between said bearing arrangement and said planar surface portion of said at least one transport element, and thereby pivot said container gripper arms about said pivot axis.

5. The container transport arrangement according to claim 4, wherein:
said adjustment element comprises a holding section and an adjustment section;
said bearing section of said bearing arrangement is disposed at said holding section; and
said adjustment section is connected to said at least one transport element and configured to be moved relative to said at least one transport element.

6. The container transport arrangement according to claim 5, wherein:
said adjustment element comprises a bolt or similar elongated structure; and
said adjustment section is connected to said holding section.

7. The container transport arrangement according to claim 6, wherein:
said adjustment section comprises an external thread; and
said at least one transport element comprises an internal thread configured and disposed to engage with said external thread of said adjustment section to adjustably connect or screw together said adjustment section and said at least one transport element.

8. The container transport arrangement according to claim 7, wherein:
said adjustment section is configured and disposed to pass through an opening in said at least one transport element, such that a projecting portion of said adjustment section projects past said planar surface portion; and
said at least one adjustment device comprises a threaded locking element configured and disposed to engage with said projecting portion to hold said adjustment element in a fixed position upon installation or adjustment of said adjustment element.

9. The container transport arrangement according to claim 8, wherein said bearing arrangement is disposed in a fixed position with respect to said holding section of said adjustment element by said bearing section.

10. The container transport arrangement according to claim 9, wherein:
at least said holding section of said adjustment element comprises a magnetizable steel, magnetizable iron, or other magnetizable material;
said bearing section comprises a magnet or is connected to a magnet; and
said holding section is configured and disposed to magnetically interact with said magnet of said bearing section.

11. The container transport arrangement according to claim 10, wherein said bearing arrangement is connected to said holding section by magnetic force to at least one of:
affix said bearing arrangement to said holding section;
secure said bearing arrangement against falling out or off of said holding section; and
minimize or prevent unintentional displacement or withdrawal of said holding section out of connection with said bearing arrangement.

12. The container transport arrangement according to claim 11, wherein:
said at least one adjustment device comprises a second adjustment element;
said second adjustment element comprises a first end portion and a second portion;
said second end portion is disposed opposite said first end portion and adjacent the underside of said at least one transport element; and
said second end portion is configured and disposed to engage with or be pressed against the underside of said at least one transport element.

13. The container transport arrangement according to claim 12, wherein:
said second adjustment element comprises a threaded bolt; and
said second adjustment element is disposed such that said second end portion is in a positive and/or non-positive fit with the underside of said at least one transport element.

14. The container transport arrangement according to claim 13, wherein said at least one container gripper comprises a plurality of container grippers.

15. The container transport arrangement according to claim 14, wherein each of said container grippers is configured to be individually adjusted by its respective adjustment device.

16. A method of adjusting a container transport arrangement configured to transport containers comprising beverage bottles and similar containers in a bottling or container handling machine of a bottling or container handling plant, said container transport arrangement comprising:
at least one transport element being configured and disposed to rotate about a vertical machine axis;
at least one container gripper being disposed at or on said at least one transport element;
said at least one container gripper being configured and disposed to grip and hold containers;
said at least one container gripper comprising a first container gripper arm and a second container gripper arm;
each of said first container gripper arm and said second container gripper arm being movable about a gripper arm axis oriented parallel or essentially parallel to said vertical machine axis;
each of said first container gripper arm and said second container gripper arm being movable to permit adjustment of said at least one container gripper between a gripping position, in which said first container gripper arm and said second container gripper arm being disposed closer together to grip a container, and a release position, in which said first container gripper arm and said second container gripper arm being disposed further apart to permit movement of a container into or out of said at least one container gripper;
said at least one container gripper comprising at least one adjustment device; and
said at least one adjustment device being adjustable to permit a height adjustment of the vertical position of said at least one container gripper relative to said at least one transport element and a horizontal plant floor surface; and
said method comprising adjusting said at least one adjustment device and thereby adjusting the vertical position of said at least one container gripper relative to said at least one transport element and a horizontal plant floor surface.

17. The method of adjusting a container transport arrangement according to claim 16, wherein:
said at least one transport element comprises a planar surface portion disposed essentially perpendicular to said vertical machine axis;
each of said container gripper arms comprises a first end portion and a second end portion;
said second end portion is disposed opposite said first end portion and adjacent said at least one adjustment device;
said at least one adjustment device is adjustable to permit adjustment of the distance between said first end portion of each of said container gripper arms and said planar surface portion; and
said step of adjusting said at least one adjustment device comprises adjusting the distance between said first end portion of each of said container gripper arms and said planar surface portion.

18. The method of adjusting a container transport arrangement according to claim 17, wherein:
said at least one adjustment device is configured and disposed to pivot said container gripper arms about a pivot axis to adjust an angular position of said container gripper arms with respect to said planar surface portion and thereby adjust the distance between said first end portion of each of said container gripper arms and said planar surface portion; and
said step of adjusting said at least one adjustment device comprises pivoting said container gripper arms about a pivot axis to adjust an angular position of said container gripper arms with respect to said planar surface portion, and thereby adjusting the distance between said first end portion of each of said container gripper arms and said planar surface portion.

19. The method of adjusting a container transport arrangement according to claim 18, wherein:
said at least one container gripper comprises a bearing arrangement configured and disposed to connect said second end portion of each of said container gripper arms to said at least one adjustment device;
said at least one adjustment device comprises an adjustment element;
said bearing arrangement comprises a bearing section operatively connected to said adjustment element;
said adjustment element is configured to be movably adjusted to move said bearing arrangement and change a distance between said bearing arrangement and said planar surface portion of said at least one transport element, and thereby pivot said container gripper arms about said pivot axis; and
said method further comprises movably adjusting said adjustment element and thereby moving said bearing arrangement and changing a distance between said bearing arrangement and said planar surface portion of said at least one transport element, and thereby pivoting said container gripper arms about said pivot axis.

20. The method of adjusting a container transport arrangement according to claim 19, wherein:
said adjustment element comprises a holding section and an adjustment section;
said bearing section of said bearing arrangement is disposed at said holding section;
said adjustment section is connected to said at least one transport element and configured to be moved relative to said at least one transport element; and
said method further comprises moving said adjustment section relative to said at least one transport element.
